(19) United States
(12) Patent Application Publication
(10) Pub. No.: US 2023/0311107 A1
(43) Pub. Date: Oct. 5, 2023

(54) HONEYCOMB STRUCTURE, ELECTRICALLY HEATED CARRIER, AND EXHAUST GAS PURIFICATION DEVICE

(71) Applicant: NGK INSULATORS, LTD., Nagoya-City (JP)

(72) Inventors: Kazumi MASE, Shenzhen-shi (CN); Yuko KOZAKI, Inazawa-City (JP)

(73) Assignee: NGK INSULATORS, LTD., Nagoya-City (JP)

(21) Appl. No.: 18/188,559

(22) Filed: Mar. 23, 2023

(30) Foreign Application Priority Data
Mar. 31, 2022 (JP) 2022-060639

(51) Int. Cl. B01J 35/00; B01J 35/04; B01D 53/94; F01N 3/20; F01N 3/28

(52) U.S. Cl. CPC B01J 35/0033; B01J 35/04; B01D 53/94; F01N 3/2013; F01N 3/2842; B01D 2255/9155; F01N 2330/32; F01N 3/2828; F01N 2370/02

(57) ABSTRACT

A honeycomb structure includes: a honeycomb structure portion which includes an outer peripheral wall, and partition walls disposed inside the outer peripheral wall and partitioning a plurality of cells forming flow paths from one end surface to the other end surface; and a pair of electrode layers provided on an outer surface of the outer peripheral wall so as to extend in a strip shape along a direction in which the cells extend and sandwich a central axis of the honeycomb structure portion; wherein a porosity P_{W} of the partition walls is 30% to 55%, and a ratio of the porosity P_{W} of the partition walls to a porosity P_{O} of the outer peripheral wall (P_{W}/P_{O}) satisfies 1<P_{W}/P_{O}≤1.8.

### CROSS REFERENCE TO RELATED APPLICATIONS

The present invention claims the benefit of priority to Japanese Patent Application No. 2022 -060639 filed on Mar. 31, 2022 with the Japanese Patent Office, the entire contents of which are incorporated herein by reference in its entirety.

### FIELD OF THE INVENTION

The present invention relates to a honeycomb structure, an electrically heated carrier provided with a honeycomb structure, and an exhaust gas purification device provided with an electrically heated carrier.

### BACKGROUND OF THE INVENTION

In recent years, electrically heated catalyst (EHC) has been proposed in order to improve the deterioration of exhaust gas purification performance immediately after engine starts-up. EHC is a system that raises the temperature of the catalyst carried on a honeycomb structure to an activation temperature before starting an engine by providing a pair of electrodes on an outer peripheral wall of a honeycomb structure made of conductive ceramics and by energizing the honeycomb structure itself to generate heat.

Since high-temperature exhaust gas flows through the exhaust gas flow paths, the honeycomb structure is required to have thermal shock resistance. Various techniques have been developed to improve thermal shock resistance. For example, Patent Literature 1 discloses that the rigidity of an electrode portion is reduced by having a portion with a thickness of 0 to 70 % of the maximum thickness of the electrode portion, thereby increasing the thermal shock resistance of the honeycomb structure. Further, Patent Literature 1 also discloses that by setting the total heat capacity of a pair of electrode portions to 2 to 150 % of the heat capacity of the entire outer peripheral wall, the amount of heat accumulated in the electrode potions is reduced, and the thermal shock resistance of the honeycomb structure is improved.

### PRIOR ART

### Patent Literature

[Patent Literature 1] WO 2012/086815 A1

### SUMMARY OF THE INVENTION

Patent Literature 1 is a technique aimed at improving the thermal shock resistance of a honeycomb structure by defining the structure of the electrodes, and the relationship of the heat capacities between the electrodes and the outer peripheral wall. However, there is still room for improving the thermal shock resistance of the honeycomb structure by means other than the above. Finding a novel means for improving the thermal shock resistance of honeycomb structures would be useful in expanding options for further technical development of EHC.

The present invention has been created in view of the above circumstances, and in one embodiment, an object of the present invention is to provide a honeycomb structure having improved thermal shock resistance by novel means. In another embodiment, an object of the present invention is to provide an electrically heated carrier provided with such a honeycomb structure. In yet another embodiment, another object of the present invention is to provide an exhaust gas purification device provided with such an electrically heated carrier.

In one embodiment, the present invention is a honeycomb structure, comprising:
a honeycomb structure portion, comprising an outer peripheral wall, and partition walls disposed inside the outer peripheral wall and partitioning a plurality of cells forming flow paths from one end surface to the other end surface; and
a pair of electrode layers provided on an outer surface of the outer peripheral wall so as to extend in a strip shape along a direction in which the cells extend and sandwich a central axis of the honeycomb structure portion;
wherein a porosity P_{W} of the partition walls is 30 % to 55 %, and
a ratio of the porosity P_{W} of the partition walls to a porosity P_{O} of the outer peripheral wall (P_{W}/P_{O}) satisfies 1<P_{W}/P_{O}≤1.8.

In another embodiment, the present invention is an electrically heated carrier, comprising:
the honeycomb structure; and
metal terminals bonded to an outer surface of each of the pair of electrode layers.

In yet another embodiment, the present invention is an exhaust gas purification device, comprising:
the electrically heated carrier; and
a tubular metal pipe accommodating the electrically heated carrier.

A honeycomb structure according to an embodiment of the present invention has high thermal shock resistance due to controlling the porosity relationship between the outer peripheral wall and the partition walls disposed inside thereof within a predetermined range. Further improvement in thermal shock resistance can be expected by combining this technology with existing technology for improving thermal shock resistance. Therefore, for example, it is possible to provide EHC with excellent thermal shock resistance that is resistant to cracking even when rapidly heated by high-temperature exhaust gas.

### BRIEF DESCRIPTION OF THE DRAWINGS

FIG. 1 is a schematic view of an electrically heated carrier according to one embodiment of the present invention when observed from one end surface;

FIG. 2 is a schematic perspective view of an electrically heated carrier according to one embodiment of the present invention;

FIG. 3 is a schematic diagram showing locations where partition wall samples and outer peripheral wall samples are collected for measuring the porosity of the partition walls and the outer peripheral wall on each cut surface;

FIG. 4 is a schematic cross-sectional view showing an exhaust gas purification device according to one embodiment of the invention;

FIG. 5 is a schematic diagram for explaining how a concave pattern is formed at the tip of a honeycomb formed body extruded from a forming machine.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### 1. Electrically Heated Carrier

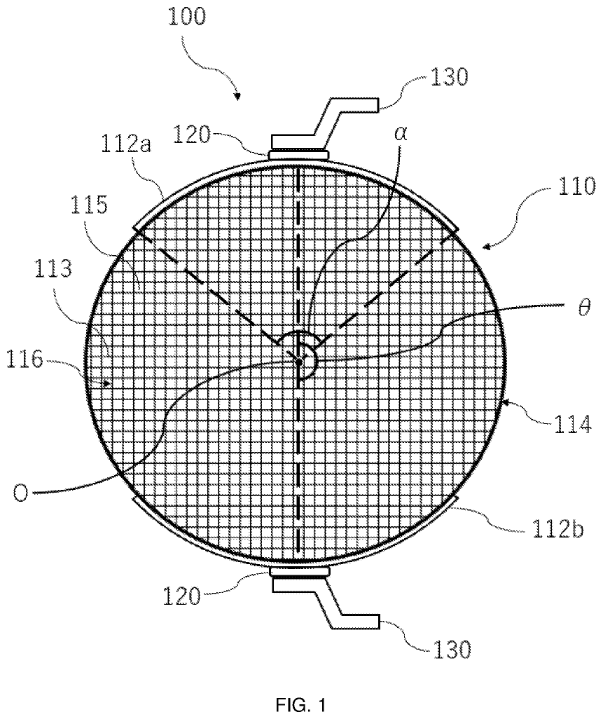

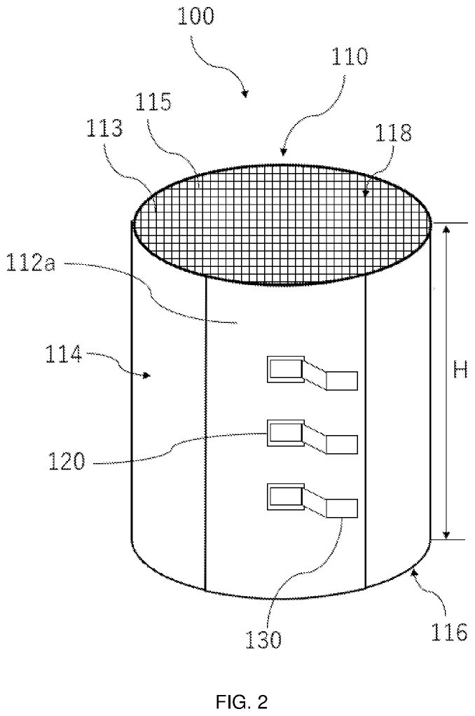

FIG. 1 is a schematic view of an electrically heated carrier 100 according to one embodiment of the present invention when observed from one end surface 116. FIG. 2 is a schematic perspective view of the electrically heated carrier 100 according to one embodiment of the present invention. The electrically heated carrier 100 comprises a honeycomb structure 110 and metal terminals 130. By carrying a catalyst on the electrically heated carrier 100, the electrically heated carrier 100 can be used as a catalyst carrier.

Examples of catalysts include precious metal catalysts and other catalysts. As a precious metal catalyst, examples include three-way catalysts and oxidation catalysts carrying precious metals such as platinum (Pt), palladium (Pd), and rhodium (Rh) on the surface of alumina pores, and containing co-catalysts such as ceria and zirconia, or NOx Storage Reduction catalysts (LNT catalysts) containing an alkaline earth metal and platinum as nitrogen oxide (NOₓ) storage components. Examples of catalysts that do not use precious metals include NOₓ selective reduction catalysts (SCR catalysts) containing copper-substituted or iron-substituted zeolites. Further, two or more catalysts selected from these catalysts may be used. The method for carrying the catalyst is also not particularly limited, and a known method for carrying the catalyst on the honeycomb structure can be employed.

### 1-1. Honeycomb structure

In one embodiment, the honeycomb structure 110 comprises:
a honeycomb structure portion, comprising an outer peripheral wall 114; and partition walls 113 disposed inside the outer peripheral wall 114 and partitioning a plurality of cells 115 forming flow paths from one end surface 116 to the other end surface 118; and
a pair of electrode layers 112a, 112b provided on an outer surface of the outer peripheral wall 114 so as to extend in a strip shape along a direction in which the cells 115 extend and sandwich a central axis of the honeycomb structure portion.

The outer shape of the honeycomb structure 110 is not particularly limited, and may be, for example, a pillar shape having round end surfaces such as circular, oval, elliptical, racetrack and elongated circular shapes, a pillar shape having polygonal end surfaces such as a triangle or a quadrangle, and a pillar shape having other irregular shaped end surfaces. The illustrated honeycomb structure 110 has a circular end surface shape and a cylindrical shape as a whole.

The height of the honeycomb structure (the length from one end surface to the other end surface) is not particularly limited, and may be appropriately set according to the applications and required performance. The relationship between the height of the honeycomb structure and the maximum diameter of each end surface (that is, the maximum length of the diameters passing through the center of gravity of each end surface of the honeycomb structure) is not particularly limited, either. Therefore, the height of the honeycomb structure may be longer than the maximum diameter of each end surface, or the height of the honeycomb structure may be shorter than the maximum diameter of each end surface.

In addition, in order to improve the thermal shock resistance (to suppress cracks occurring in the circumferential direction of the outer peripheral wall), the size of the honeycomb structure 110 is preferably such that the area of one end surface is 2,000 to 20,000 mm², and more preferably 5,000 to 15,000 mm².

The outer peripheral wall 114 and the partition walls 113 have higher volume resistivity than the electrode layers 112a, 112b, but are electrically conductive. The volume resistivity of the outer peripheral wall 114 and the partition walls 113 is not particularly limited as long as they can generate heat by Joule heat when energized, but it is preferably 0.1 to 200Ω·cm, more preferably 1 to 200Ω·cm, and even more preferably 10 to 100Ω·cm, when measured at 25° C. by a four-terminal method.

The material of the outer peripheral wall 114 and the partition walls 113 is not particularly limited as long as it can generate heat by Joule heat when energized, and metal and ceramics (in particular, conductive ceramics) can be used alone or in combinations. The material of the outer peripheral wall 114 and the partition walls 113 is not limited, but may comprise one or more selected from oxide ceramics such as alumina, mullite, zirconia and cordierite, and non-oxide ceramics such as silicon carbide, silicon nitride and aluminum nitride. In addition, a silicon carbide-silicon composite material, a silicon carbide-graphite composite material, or the like can also be used. Among these, from the viewpoint of achieving both thermal shock resistance and conductivity, it is preferable that the material the outer peripheral wall 114 and the partition walls 113 contain a silicon carbide-silicon composite material or silicon carbide as the main component. Furthermore, by using the same material as the partition walls 113, it is possible to match thermal expansion and the like, thereby suppressing cracks and the like during firing. Therefore, in addition to the material of the outer peripheral wall 114 and the partition walls 113, it is preferable that the material constituting the electrode layers 112a, 112b also contains a silicon carbide-silicon composite material or silicon carbide as the main component.

When it is said that the material of the outer peripheral wall 114 and the partition walls 113, and the material constituting the electrode layers 112a, 112b contains a silicon carbide-silicon composite material as the main component, it means that the outer peripheral wall 114, the partition walls 113, and the electrode layers 112a, 112b comprise 90% by mass or more of the silicon carbide-silicon composite material (total mass), respectively. Here, the silicon carbide-silicon composite material contains silicon carbide particles as an aggregate and silicon as a binder for binding the silicon carbide particles, and it is preferable that multiple silicon carbide particles are bound by the silicon so as to form pores between the silicon carbide particles. When it is said that the material constituting the outer peripheral wall 114, the partition walls 113, and the electrode layers 112a, 112b contains silicon carbide as the main component, it means that the outer peripheral wall 114, the partition walls 113, and the electrode layers 112a, 112b comprise 90% by mass or more of silicon carbide (total mass), respectively.

When the outer peripheral wall 114 and the partition walls 113, and furthermore, the electrode layers 112a, 112b, contain a silicon carbide-silicon composite material, a ratio of the “mass of silicon as a binder” contained in the outer peripheral wall 114, the partition walls 113, and the electrode layers 112a, 112b to a total of the “mass of silicon carbide particles as an aggregate” contained in the outer peripheral wall 114, the partition walls 113, and the electrode layers 112a, 112b, and the “mass of silicon as a binder” contained in the outer peripheral wall 114, the partition walls 113, and the electrode layers 112a, 112b is preferably 10 to 40% by mass, more preferably 15 to 35% by mass, respectively. When it is 10% by mass or more, the strength of the outer peripheral wall 114, the partition walls 113, and the electrode layers 112a, 112b is fully maintained. When it is 40% by mass or less, it becomes easier to retain the shape during firing.

The partition walls 113 may be solid, but are preferably porous. Specifically, the porosity P_{W} of the partition walls 113 is preferably 30 to 55%, more preferably 30 to 45%. When the porosity is 30% or more, it becomes easier to suppress deformation during firing. When the porosity is 55% or less, the strength of the honeycomb structure 110 is sufficiently maintained. In addition, the term “solid” means that the porosity is 5% or less.

Further, the porosity of the outer peripheral wall 114 is preferably 30% to 55%, more preferably 30% to 40%.

When high-temperature gas flows through the honeycomb structure 110, the flow rate of the gas flowing through the honeycomb structure 110 tends to be greater in the central portion than in the outer peripheral portion. Accordingly, to mitigate the temperature difference between the outer peripheral portion and the central portion of the honeycomb structure 110 and improve the thermal shock resistance of the honeycomb structure 110, it is desirable to set the porosity P_{W} of the partition walls to 30% to 55% so that the porosity of the partition walls 113 is increased to lighten the entire honeycomb structure 110 and reduce the heat capacity.

Further, conventionally, since the partition walls 113 and the outer peripheral wall 114 are generally formed by integral forming, the porosity of the partition walls 113 and the outer peripheral wall 114 are basically the same. On the other hand, the electrode layers 112a, 112b are normally made denser than the partition walls 113 and the outer peripheral wall 114 in order to spread electric current. Therefore, when the porosity of the outer peripheral wall 114 is the same value as the porosity of the partition wall 113, the rigidity of the electrode layers 112a, 112b is usually higher than that of the honeycomb structure 110 (the peripheral wall). Therefore, a difference in rigidity is generated between the electrode layers 112a, 112b and the outer peripheral wall 114, which may cause cracks in the outer peripheral wall 114.

Therefore, in the honeycomb structure 110 according to one embodiment of the present invention, the porosity of the outer peripheral wall 114 is made smaller than the porosity of the partition walls 113, thereby making the outer peripheral wall 114 relatively dense and increasing the rigidity of the outer peripheral wall. Specifically, it is preferable that the ratio (P_{W}/P_{O}) of the porosity P_{W} of the partition walls 113 to the porosity P_{O} of the outer peripheral wall 114 satisfies 1<P_{W}/P_{O}. When P_{W}/P_{O} is greater than 1, the outer peripheral wall 114 becomes relatively dense, thereby reducing the difference in rigidity between the electrode layers 112a, 112b and the outer peripheral wall 114. In this way, occurrence of cracks in the outer peripheral wall 114 is suppressed, and the thermal shock resistance of the honeycomb structure 110 is improved. P_{W}/P_{O} more preferably satisfies 1.05≤P_{W}/P_{O}, and even more preferably satisfies 1.1≤P_{W}/P_{O}. On the other hand, from the viewpoint of ease of manufacture, it is preferable to satisfy P_{W}/P_{O}≤1.8, more preferably P_{W}/P_{O}≤1.5, and even more preferably P_{W}/P_{O}≤1.45, and even more preferably P_{W}/P_{O}≤1.3. Therefore, in one embodiment, 1<P_{W}/P_{O}≤1.8 is satisfied, in a preferred embodiment, 1.05≤P_{W}/P_{O}≤1.5 is satisfied, in a more preferred embodiment, 1.1≤P_{W}/P_{O}≤1.45 is satisfied, and in an even more preferred embodiment, 1.1≤P_{W}/P_{O}≤1.3 is satisfied.

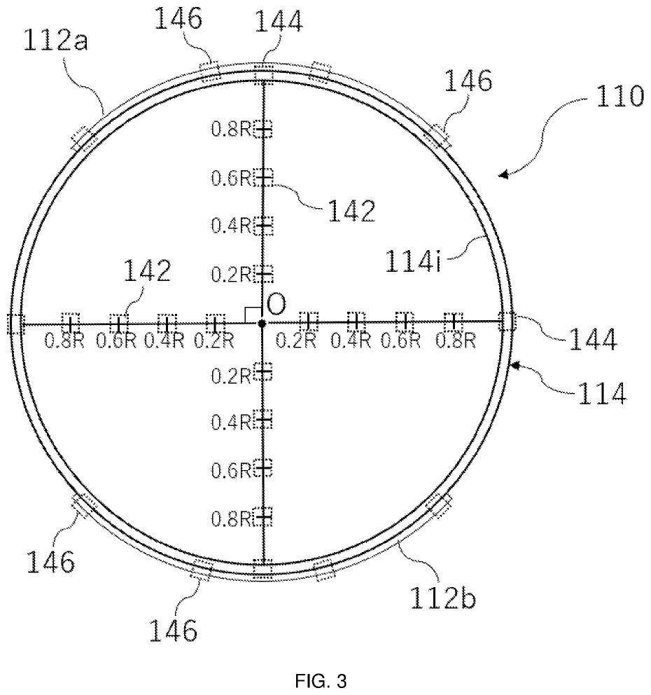

In the present specification, the porosity P_{W} of the partition walls of the honeycomb structure is measured by the following procedure. First, assuming the height of the honeycomb structure is H, the coordinate axis is taken in the direction of the height, the coordinate value of one end surface is set to 0, and the coordinate value of the other end surface is set to 1.0H. The honeycomb structure is cut at coordinate values of 0.2H, 0.5H, and 0.8H in the direction perpendicular to the direction in which the cells extend, thereby obtaining a first divisional portion of 0 to 0.2H, a second divisional portion of 0.2H to 0.5H, a third divisional portion of 0.5H to 0.8H, and a fourth divisional portion of 0.8H to 1.0H. Next, partition wall samples including the cut surface of the coordinate value of 0.2H on the first divisional portion (referred to as “first cut surface”), the cut surface of the coordinate value of 0.5H on the second divisional portion (or the coordinate value of 0.5H on the third divisional portion) (referred to as “second cut surface”), and the cut surface of the coordinate value of 0.8H on the fourth divisional portion (referred to as “third cut surface”) are collected, respectively. For each cut surface, assuming R is the length from the center of gravity (central axis O) to the inner peripheral surface 114i of the outer peripheral wall 114, the coordinate axis is taken in the radial direction, the coordinate value of the center of gravity (central axis O) is set to 0, and the coordinate value of the inner peripheral surface 114i of the outer peripheral wall 114 is set to 1.0R. Partition wall samples 142 including coordinate values of 0.2R, 0.4R, 0.6R, and 0.8R (size: the above-described cut surface (5 mm×5 mm)×depth 5 mm) are taken at intervals of a central angle 90° with respect to the center of gravity (central axis O), respectively (see FIG. 3).

Then, the above-described cut surface of each sample is observed at a magnification of 50 (field size: 1 mm×1 mm) with a scanning electron microscope (SEM) to acquire an SEM image of the partition walls. By performing image analysis on the obtained SEM image, the solid portions of the sample and the void portions (pores) of the sample are binarized by the mode method. Then, the percentage of the ratio of void portions in the sample to the total area of the solid portions and the void portions of the sample is calculated, and this value is taken as the porosity of the sample. The average value of the porosities of all partition wall samples is used as the measured value of the porosity P_{W} of the partition walls of the honeycomb structure. Incidentally, when measuring the porosity of an electrically heated catalyst carrier with a catalyst carried on the honeycomb structure, the catalyst portions are regarded as the void portions of the partition walls.

In the present specification, the porosity P_{O} of the outer peripheral wall of the honeycomb structure is measured by the following procedure. First, assuming the height of the honeycomb structure is H, the coordinate axis is taken in the direction of the height, the coordinate value of one end surface is set to 0, and the coordinate value of the other end surface is set to 1.0H. The honeycomb structure is cut at coordinate values of 0.2H, 0.5H, and 0.8H in the direction perpendicular to the direction in which the cells extend, thereby obtaining a first divisional portion of 0 to 0.2H, a second divisional portion of 0.2H to 0.5H, a third divisional portion of 0.5H to 0.8H, and a fourth divisional portion of 0.8H to 1.0H. Next, outer peripheral wall samples including the cut surface of the coordinate value of 0.2H on the first divisional portion (referred to as “first cut surface”), the cut surface of the coordinate value of 0.5H on the second divisional portion (or the coordinate value of 0.5H on the third divisional portion) (referred to as “second cut surface”), and the cut surface of the coordinate value of 0.8H on the fourth divisional portion (referred to as “third cut surface”) are collected, respectively. For each cut surface, outer peripheral wall samples 144 (size: the above-described cut surface (5 mm×5 mm)×depth 5 mm, portions other than the outer peripheral wall may be included.) are collected at four locations at intervals of a central angle 90° with respect to the center of gravity (central axis O), respectively (see FIG. 3).

Then, the above-described cut surface of each sample is observed at a magnification of 50 (field size: 1 mm×1 mm) with a scanning electron microscope (SEM) to acquire an SEM image of the outer peripheral walls. By performing image analysis on the obtained SEM image, the solid portions of the sample and the void portions (pores) of the sample are binarized by the mode method. Then, the percentage of the ratio of void portions in the sample to the total area of the solid portions and void portions of the sample is calculated, and this value is taken as the porosity of the sample. The average value of the porosities of all the outer peripheral wall samples is used as the measured value of the porosity P_{O} of the outer peripheral wall of the honeycomb structure.

The shape of the cells in the cross-section perpendicular to the direction in which the cells extend 115 is not limited, but is preferably quadrangular, hexagonal, octagonal, or a combination thereof. Among these, quadrangles and hexagons are preferred. Such a cell shape reduces the pressure loss when exhaust gas is caused to flow through the honeycomb structure 110, resulting in excellent purification performance of the catalyst. A hexagonal shape is particularly preferable from the viewpoint that it is easy to achieve both structural strength and heat generation uniformity.

The cells 115 may penetrate from one end surface 116 to the other end surface 118. In addition, the cells 115 may be such that first cells sealed on one end surface 116 and having openings on other end surface 118, and second cells having openings on one end surface 116 and sealed on the other end surface 118, are alternately arranged adjacent to each other with the partition walls 113 interposed therebetween.

Providing the honeycomb structure 110 with the outer peripheral wall 114 is useful from the viewpoint of ensuring the structural strength of the honeycomb structure 110 and suppressing leakage of the fluid flowing through the cells 115 from the outer peripheral side surface. From this point of view, the thickness of the outer peripheral wall 114 is preferably 0.1 mm or more, more preferably 0.15 mm or more, and even more preferably 0.2 mm or more. However, if the outer peripheral wall 114 is too thick, the strength becomes too high, and the strength balance with the partition walls 113 may be lost, resulting in a decrease in thermal shock resistance. Therefore, the thickness of the outer peripheral wall 114 is preferably 1.0 mm or less, more preferably 0.7 mm or less, and even more preferably 0.5 mm or less. In the present specification, the thickness T_{O} of the outer peripheral wall 114 is defined as an average value obtained by measuring the thickness of the outer peripheral wall of all the outer peripheral wall samples collected when measuring the porosity P_{O} of the outer peripheral wall 114 as described above. The thickness of the outer peripheral wall in each outer peripheral wall sample is defined as the thickness in the direction normal to the tangential line of the outer surface of the outer peripheral wall 114 at any measurement point of the outer peripheral wall sample.

The thickness of the partition walls 113 that partition the cells 115 is preferably 0.1 to 0.3 mm, more preferably 0.15 to 0.25 mm. When the partition walls 113 have a thickness of 0.1 mm or more, it is possible to suppress a decrease in the strength of the honeycomb structure 110. When the partition walls 113 have a thickness of 0.3 mm or less, it is possible to suppress an increase in pressure loss when the honeycomb structure 110 is used as a catalyst carrier to carry a catalyst and an exhaust gas flows through it. In the present specification, the thickness of the partition walls 113 is defined as a crossing length of a line segment that crosses the partition wall 113 when the centers of gravity of adjacent cells 115 are connected by this line segment in a cross-section perpendicular to the direction in which the cells 115 extend.

The honeycomb structure 110 preferably has a cell density of 40 to 150 cells/cm², more preferably 70 to 100 cells/cm², in a cross-section perpendicular to the direction in which the cells 115 extend. By setting the cell density within such a range, the purification performance of catalyst can be enhanced while reducing the pressure loss when exhaust gas is caused to flow through the honeycomb structure 110. When the cell density is 40 cells/cm² or more, a sufficient catalyst carrying area can be ensured. When the cell density is 150 cells/cm² or less, the pressure loss when exhaust gas flows is suppressed from becoming excessively large if the honeycomb structure 110 is used as a catalyst carrier to carry a catalyst. The cell density is a value obtained by dividing the number of cells by the area of one end surface of the honeycomb structure 110 excluding the outer peripheral wall portion.

On the outer surface of the outer peripheral wall 114, by providing electrode layers 112a, 112b having a volume resistivity lower than that of the outer peripheral wall 114, electric current spreads easily in the circumferential direction of the honeycomb structure 110 and in the direction in which the cells 115 extend, so it is possible to improve the heat generation uniformity of the honeycomb structure 110. In the cross-section perpendicular to the direction in which the cells 115 extend, an angle θ (0°≤θ≤180°) formed by two line segments extending from the center of each of the pair of electrode layers 112a, 112b in the circumferential direction to the central axis O of the honeycomb structure 110 is preferably 150°≤θ≤180°, more preferably 160°≤θ≤180°, even more preferably 170°≤θ≤180°, and 180° is most preferred.

By making the volume resistivity of the electrode layers 112a, 112b lower than the volume resistivity of the partition walls 113 and the outer peripheral wall 114, electricity tends to flow preferentially through the electrode layers 112a, 112b, and when energized, electricity tends to spread in the circumferential direction of the honeycomb structure 110 and in the direction in which the cells 115 extend. The volume resistivity of the electrode layers 112a, 112b is preferably 1/10 or less, more preferably 1/20 or less, and even more preferably 1/30 or less of the volume resistivity of the partition walls 113 and the outer peripheral wall 114. However, if the difference in volume resistivity between the two becomes too large, the current concentrates between the ends of the opposing electrode layers 112a, 112b, and the heat generation of the honeycomb structure 110 is biased. Therefore, the volume resistivity of the electrode layers 112a, 112b is preferably 1/200 or more, more preferably 1/150 or more, and even more preferably 1/100 or more of the volume resistivity of the partition walls 113 and the outer peripheral wall 114. In the present invention, the volume resistivity of the electrode layer, the partition walls and the outer peripheral wall is the value measured at 25° C. by a four-terminal method.

Although there are no particular restrictions on the areas where the electrode layers 112a, 112b are formed, from the viewpoint of improving the heat generation uniformity of the honeycomb structure 110, it is preferable that each of the electrode layers 112a, 112b extend on the outer surface of the outer peripheral wall 114 in a strip shape, in the circumferential direction of the honeycomb structure 110 and in the direction in which the cells 115 extend. Specifically, in the cross-section perpendicular to the direction in which the cells 115 extend, a central angle α formed by two line segments connecting both side ends of each of the electrode layers 112a, 112b in the circumferential direction and the central axis O is preferably 30° or more, more preferably 40° or more, and even more preferably 60° or more, from the viewpoint of spreading the current in the circumferential direction to improve heat generation uniformity. However, if the central angle α is too large, less current passes through the interior of the honeycomb structure 110 and more current passes near the outer peripheral wall 114. Therefore, from the viewpoint of heat generation uniformity of the honeycomb structure 110, the central angle α is preferably 140° or less, more preferably 130° or less, and even more preferably 120° or less. In addition, it is desirable that the each of the electrode layers 112a, 112b extend over 80% or more, preferably over 90% or more of the length between both end surfaces of the honeycomb structure 110, and more preferably on the entire length. The electrode layers 112a, 112b may be composed of a single layer, or may have a laminated structure in which multiple layers are laminated.

The thickness of the electrode layers 112a, 112b is preferably 0.01 to 5 mm, more preferably 0.01 to 3 mm. Heat generation uniformity can be increased by setting it to such a range. When the thickness of the electrode layers 112a, 112b is 0.01 mm or more, the electrical resistance is appropriately controlled, and heat can be generated more uniformly. When the thickness of the electrode layers 112a, 112b is 5 mm or less, the risk of breakage during canning is reduced. In the present specification, the thickness (Te ) of the electrode layers of the honeycomb structure 110 is defined as the average value obtained by measuring the thickness of the electrode layers of all the electrode layer samples collected when measuring the porosity (Pe ) of the electrode layers, which will be described later. The thickness of the electrode layer in each electrode layer sample is defined as the thickness in the direction normal to the tangential line of the outer surface of the electrode layer at any measurement point of the electrode layer sample.

The electrode layers 112a, 112b are preferably porous. Specifically, the porosity (Pe ) of the electrode layers 112a, 112b is preferably 30% to 55%, more preferably 30% to 40%. When the porosity is 55% or less, it is possible to prevent the electric current flowing through the electrode layers from becoming difficult to flow and the strength of the electrode layer from being excessively lowered. When the porosity is 30% or more, it is possible to prevent the electrode layers from becoming too dense and the rigidity from becoming too high.

In the present specification, the porosity (Pe ) of the electrode layers of the honeycomb structure is measured by the following procedure. First, assuming the height of the honeycomb structure is H, the coordinate axis is taken in the direction of the height, the coordinate value of one end surface is set to 0, and the coordinate value of the other end surface is set to 1.0H. The honeycomb structure is cut at coordinate values of 0.2H, 0.5H, and 0.8H in the direction perpendicular to the direction in which the cells extend, thereby obtaining a first divisional portion of 0 to 0.2H, a second divisional portion of 0.2H to 0.5H, a third divisional portion of 0.5H to 0.8H, and a fourth divisional portion of 0.8H to 1.0H. Next, electrode layer samples including the cut surface of the coordinate value of 0.2H on the first divisional portion (referred to as “first cut surface”), the cut surface of the coordinate value of 0.5H on the second divisional portion (or the coordinate value of 0.5H on the third divisional portion) (referred to as “second cut surface”), and the cut surface of the coordinate value of 0.8H on the fourth divisional portion (referred to as “third cut surface”) are collected, respectively. For each cut surface, electrode layer samples 146 (size: the above-described cut surface (5 mm×5 mm)×depth 5 mm, portions other than the electrode layers may be included.) are collected from four locations (eight locations in total) at regular intervals without bias from one end to the other end in the circumferential direction of each of the pair of electrode layers 112a, 112b, respectively (see FIG. 3).

Then, the above-described cut surface of each sample is observed at a magnification of 50 (field size: 1 mm×1 mm) with a scanning electron microscope (SEM) to acquire an SEM image of the electrode layers. By performing image analysis on the obtained SEM image, the solid portions of the sample and the void portions (pores) of the sample are binarized by the mode method. Then, the percentage of the ratio of void portions in the sample to the total area of the solid portions and void portions of the sample is calculated, and this value is taken as the porosity of the sample. The average value of the porosities of all the electrode layer samples is used as the measured value of the porosity (Pe ) of the electrode layers of the honeycomb structure.

In order to improve the thermal shock resistance, the thickness Te (unit: mm) of the electrode layers 112a, 112b, the porosity Pe (unit: %) of the electrode layers 112a, 112b, the thickness T_{O} (unit: mm) of the outer peripheral wall 114, and the porosity P_{O} (unit: %) of the outer peripheral wall 114 preferably satisfy the relationship 0.25≤(P_{O}/T_{O})/(Pe/Te)≤1.0. (P_{O}/T_{O})/(Pe/Te) is an indication showing the rigidity balance between the electrode layers 112a, 112b and the outer peripheral wall 114.

By setting the upper limit of (P_{O}/T_{O})/(Pe/Te) to 1.0 or less, preferably 0.75 or less, and more preferably 0.7 or less, the rigidity of the electrode layers 112a, 112b can be relatively low. By making the rigidity of the electrode layers 112a, 112b relatively low, the stress generated in the honeycomb structure can be reduced even if there is a sudden temperature change. As a result, the thermal shock resistance of the honeycomb structure is improved.

The lower limit of (P_{O}/T_{O})/(Pe/Te) is preferably 0.25 or more, more preferably 0.3 or more, and even more preferably 0.4 or more.

The material of the electrode layers 112a, 112b is not limited, but a composite material (cermet) of metal and ceramics (in particular, conductive ceramics) can be used. Examples of metals include single metals such as Cr, Fe, Co, Ni, Si, and Ti, and alloys containing at least one metal selected from these metals. Examples of ceramics include, but are not limited to, silicon carbide (SiC), as well as metal compounds such as metal silicides such as tantalum silicide (TaSi₂) and chromium silicide (CrSi₂). Specific examples of composite materials (cermets) of metal and ceramics include composite materials of metallic silicon and silicon carbide (same as the “silicon carbide-silicon composite material” described above.); composite materials of metal silicide (such as tantalum silicide and chromium silicide), metallic silicon and silicon carbide; and furthermore, from the viewpoint of reducing thermal expansion, composite materials in which one or more kinds of insulating ceramics such as alumina, mullite, zirconia, cordierite, silicon nitride and aluminum nitride are added to one or more kinds of the above metals can be mentioned. As the material of the electrode layers 112a, 112b, among the various metals and ceramics described above, a composite material of metallic silicon and silicon carbide, or a composite material of metal silicide (such as tantalum silicide or chromium silicide), metallic silicon and silicon carbide is preferable for the reason that the partition walls and the outer peripheral wall can be fired at the same time, contributing to simplification of the manufacturing process.

### 1-2. Metal Terminal

A metal terminal 130 is directly or indirectly joined to the respective outer surfaces of the pair of electrode layers 112a, 112b. When a voltage is applied to the honeycomb structure 110 through the metal terminals 130, the honeycomb structure 110 can be heated by Joule heat. Therefore, the honeycomb structure 110 can also be suitably used as a heater. The applied voltage is preferably 12 to 900 V, more preferably 48 to 600 V, but the applied voltage can be changed as appropriate.

Although the metal terminals 130 and the electrode layers 112a, 112b may be directly joined, for the purpose of alleviating the difference in thermal expansion between the electrode layers 112a, 112b and the metal terminals 130 and improving the joining reliability of the metal terminals 130, they may be joined via one or more underlying layers 120. Therefore, in a preferred embodiment, the honeycomb structure 110 has a pair of electrode layers 112a, 112b provided on the outer peripheral wall 114 so as to face each other and sandwich the central axis of the honeycomb structure 110, and one or more metal terminals 130 are joined to each of the electrode layers 112a, 112b via an underlying layer 120.

From the viewpoint of improving the joining reliability, it is preferable to decrease the coefficient of thermal expansion stepwise in the order of metal terminal 130→(underlying layer 120) →electrode layers 112a, 112b→outer peripheral wall 114. In addition, the “coefficient of thermal expansion” here means the coefficient of linear expansion measured according to JIS R1618: 2002 when changing from 25° C. to 1000° C.

The material of the metal terminal 130 is not particularly limited as long as it is metal, and a single metal, an alloy, or the like can be used. However, from the viewpoint of corrosion resistance, volume resistivity and coefficient of linear expansion, for example, an alloy containing at least one selected from the group consisting of Cr, Fe, Co, Ni and Ti is preferred, and stainless steel and Fe-Ni alloys are more preferred. The shape and size of the metal terminal 130 are not particularly limited, and can be appropriately designed according to the size, the current-carrying performance, and the like of the honeycomb structure 110.

The material of the underlying layer 120 is not limited, but a composite material (cermet) of metal and ceramics (in particular, conductive ceramics) can be used. The coefficient of thermal expansion of the underlying layer 120 can be controlled by adjusting the compounding ratio of metal and ceramics, for example.

The underlayer 120 preferably contains one or more metals selected from Ni-based alloys, Fe-based alloys, Ti-based alloys, Co-based alloys, metallic silicon, and Cr, although not limited thereto.

The underlayer 120 preferably contains one or more ceramics selected from oxide ceramics such as alumina, mullite, zirconia, glass and cordierite, and non-oxide ceramics such as silicon carbide, silicon nitride and aluminum nitride, although not limited thereto.

Although the thickness of the underlayer 120 is not particularly limited, it is preferably 0.1 to 1.5 mm, more preferably 0.3 to 0.5 mm, from the viewpoint of suppressing cracks. The thickness of the underlying layer 120 is measured by observing the location of the underlying layer 120 whose thickness is to be measured in the cross-section perpendicular to the direction in which the cells extend, and defined as the thickness in the direction normal to the tangential line of the outer surface of the underlying layer 120 at the measurement location.

The method of joining the metal terminals 130 with the electrode layers 112a, 112b or with the underlying layer 120 is not particularly limited, and examples thereof include thermal spraying, welding and brazing.

### 2. Exhaust Gas Purification Device

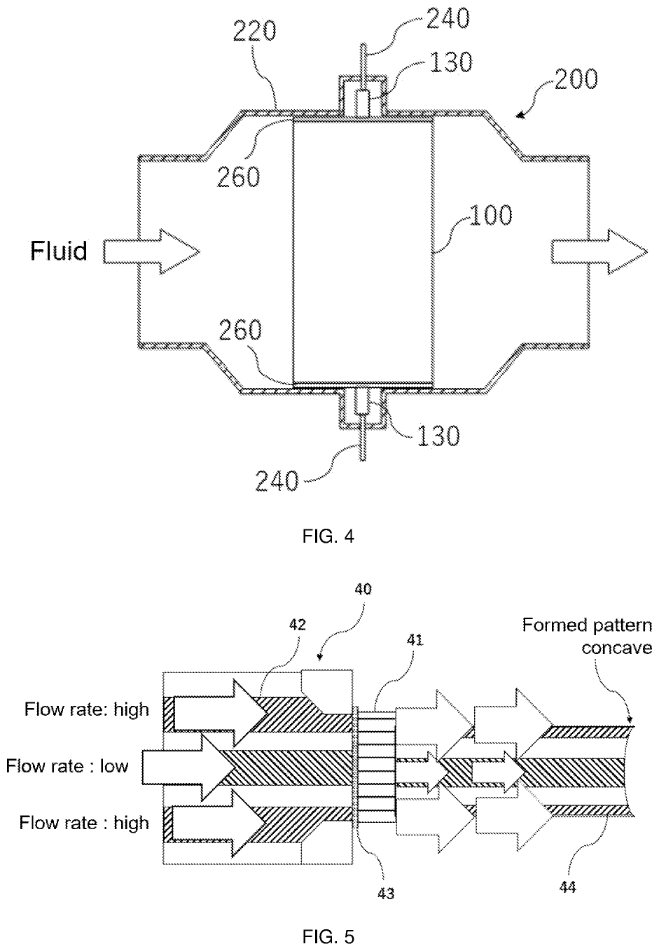

The electrically heated carrier 100 according to an embodiment of the present invention can be used in an exhaust gas purification device. Referring to FIG. 4, the exhaust gas purification device 200 comprises an electrically heated carrier 100 and a tubular metal pipe 220 that accommodates the electrically heated carrier 100. An electrical wire 240 for power supply can be connected to the metal terminals 130 of the electrically heated carrier 100. The material of the metal pipe 220 is not limited, and stainless steel can be mentioned, for example.

In the exhaust gas purification device 200, the electrically heated carrier 100 can be installed on the way of the flow path of a fluid such as automobile exhaust gas. The electrically heated carrier 100 can be fixed in the metal pipe 220 by, for example, push-canning in which it is pushed into the metal pipe 220 and fitted so that the direction in which the cells extend and the direction in which the metal pipe 220 extend match. A cushion material 260 can be provided between the metal pipe 220 and the electrically heated carrier 100.

The material of the cushion material 260 is not limited, but ceramic fibers such as alumina fibers and mullite fibers are preferable for the reasons of suppressing displacement of the electrically heated carrier and maintaining contact pressure between the metal pipe and the electrically heated carrier.

### 3. Manufacturing Method

Next, a method for manufacturing an electrically heated carrier according to an embodiment of the present invention will be exemplified. The electrically heated carrier can be manufactured by a manufacturing method comprising a step 1 of obtaining a honeycomb formed body; a step 2 of obtaining an unfired honeycomb structure with electrode layer forming paste; a step 3 of obtaining a honeycomb structure by firing the unfired honeycomb structure with the electrode layer forming paste; and a step 4 of joining metal terminals to the electrode layers.

### Step 1

Step 1 is a step of preparing a honeycomb formed body, which is a precursor of a honeycomb structure. The honeycomb formed body can be prepared according to a method for preparing a honeycomb formed body in a known method for manufacturing a honeycomb structure. For example, first, metallic silicon powder (metallic silicon), a binder, a surfactant, a pore-forming material, water, and the like are added to silicon carbide powder (silicon carbide) to prepare a forming raw material. It is preferable that the mass of the metallic silicon powder is 10 to 40% by mass with respect to the sum of the mass of the silicon carbide powder and the mass of the metallic silicon powder. The average particle size of silicon carbide particles in the silicon carbide powder is preferably 3 to 50 μm, more preferably 3 to 40 μm. The average particle size of the metallic silicon particles in the metallic silicon powder is preferably 2 to 35 μm. The average particle size of silicon carbide particles and metallic silicon particles refers to the volume-based arithmetic mean size when the frequency distribution of particle sizes is measured by a laser diffraction method. The silicon carbide particles are fine particles of silicon carbide that constitute the silicon carbide powder, and the metallic silicon particles are fine particles of metallic silicon that constitute the metallic silicon powder. It should be noted that this is the composition of a forming raw material when the material of the honeycomb structure is a silicon-silicon carbide composite material, and when the material of the honeycomb structure is silicon carbide, metallic silicon is not added.

As the binder, methylcellulose, hydroxypropylmethylcellulose, hydroxypropoxylcellulose, hydroxyethylcellulose, carboxymethylcellulose, polyvinyl alcohol and the like can be mentioned. Among these, it is preferable to use methyl cellulose and hydroxypropoxyl cellulose in combination. The amount of the binder is preferably 2.0 to 10.0 parts by mass when the total mass of the silicon carbide powder and the metallic silicon powder is 100 parts by mass.

As the surfactant, ethylene glycol, dextrin, fatty acid soap, polyalcohol, and the like can be used. One type of them can be used alone, and two or more types can be used in combination. The amount of the surfactant is preferably 0.1 to 2.0 parts by mass when the total mass of the silicon carbide powder and the metallic silicon powder is 100 parts by mass.

The pore-forming material is not particularly limited as long as it forms pores after firing, and examples thereof include graphite, starch, foam resin, water-absorbing resin, silica gel, and the like. The amount of the pore-forming material is preferably 0.5 to 10.0 parts by mass when the total mass of the silicon carbide powder and the metallic silicon powder is 100 parts by mass. The average particle size of the pore-forming material is preferably 10 to 30 μm. The average particle size of the pore-forming material refers to the volume-based arithmetic mean size when the frequency distribution of particle sizes is measured by a laser diffraction method. When the pore-forming material is a water-absorbing resin, the average particle size of the pore-forming material means the average particle size after water absorption.

The content of water is preferably 20 to 60 parts by mass when the total mass of the silicon carbide powder and the metallic silicon powder is 100 parts by mass.

Next, after kneading the obtained forming raw material to form a green body, the green body is extrusion molded, thereby preparing a pillar-shaped honeycomb formed body having an outer peripheral wall and partition walls. As a method for increasing the porosity of the partition walls relative to the porosity of the outer peripheral wall, a method of relatively reducing the amount of the pore-forming material added to the outer peripheral portion of the green body that will form the outer peripheral wall, and a method of reducing the flow rate and volume of the green body in the partition wall portion of the honeycomb formed body relative to the outer peripheral wall portion thereof during extrusion molding can be mentioned. For extrusion molding, a die having a desired overall shape, cell shape, partition wall thickness, cell density, and the like can be used. Next, it is preferable to perform drying on the obtained honeycomb formed body. When the length of the honeycomb formed body in the central axis direction is not the desired length, both ends of the honeycomb formed body can be cut to obtain the desired length. The honeycomb formed body after drying is called a honeycomb dried body.

As a modification of step 1, the honeycomb formed body may be once fired. That is, in this modification, a honeycomb formed body is fired to prepare a honeycomb fired body, and step 2 is performed on the honeycomb fired body.

### Step 2

Step 2 is a step of applying an electrode layer forming paste to the side surface of the honeycomb formed body to obtain an unfired honeycomb structure with the electrode layer forming paste. The electrode layer forming paste can be obtained by appropriately adding various additives to raw material powders (metal powder, ceramic powder, pore-forming material, and the like) blended according to the required properties of the electrode layer, and kneading the mixture. The porosity of the electrode layers can be controlled by adjusting the amount of the pore-forming material added to the electrode layer forming paste. Although the average particle size of the raw material powder is not limited, it is preferably, for example, 5 to 50 μm, more preferably 10 to 30 μm. The average particle size of the raw material powder refers to the volume-based arithmetic mean size when the frequency distribution of particle sizes is measured by a laser diffraction method.

Next, the electrode layer forming paste thus obtained is applied to desired portions of the side surface of the formed honeycomb body (typically a honeycomb dried body) to obtain an unfired honeycomb structure with the electrode layer forming paste. The method of formulating the electrode layer forming paste and the method of applying the electrode layer forming paste to the honeycomb formed body can be carried out according to a known method for manufacturing a honeycomb structure. However, in order to make the volume resistivity of the electrode layers lower than that of the outer peripheral wall and the partition walls, the metal content ratio can be made higher than that of the outer peripheral wall and the partition walls, or the particle size of the metal particles in the raw material powder can be reduced.

### Step 3

Step 3 is a step of firing the unfired honeycomb structure with the electrode layer forming paste to obtain a honeycomb structure. Before firing, the unfired honeycomb structure with the electrode layer forming paste may be dried. Moreover, before firing, degreasing may be performed to remove the binder and the like. The method of degreasing and firing is not particularly limited, and firing can be performed using an electric furnace, a gas furnace, or the like. As the firing conditions, although they depend on the material of the honeycomb structure, it is preferable to heat at 1400 to 1500° C. for 1 to 20 hours in an inert atmosphere such as nitrogen or argon.

### Step 4

Step 4 is a step of joining metal terminals to the electrode layers. The joining method is not particularly limited, but examples thereof include thermal spraying, welding and brazing. From the viewpoint of improving the joining reliability between the electrode layers and the metal terminals, underlying layers may be formed by a method such as thermal spraying.

### EXAMPLES

The following examples are provided for a better understanding of the invention and its advantages, but are not intended to limit the scope of the invention.

### I. Manufacture of Honeycomb Structure (Comparative Example 1, Examples 1 to 9)

### 1. Preparation of Cylindrical Green Body

A ceramic raw material was prepared by mixing silicon carbide (SiC) powder and metallic silicon (Si) powder at a mass ratio of 80:20. Then, hydroxypropylmethyl cellulose as a binder, a water-absorbing resin as a pore-forming material were added to the ceramic raw material, and water was added to obtain a forming raw material. Then, the forming raw material was kneaded by a vacuum kneader to prepare a cylindrical green body.

At this time, in all the Examples and Comparative Examples, the content of the binder was 7 parts by mass when the total of the silicon carbide (SiC) powder and the metallic silicon (Si) powder was 100 parts by mass. In all the Examples and Comparative Examples, the content of water was 42 parts by mass when the total of the silicon carbide (SiC) powder and the metallic silicon (Si) powder was 100 parts by mass. In all the Examples and Comparative Examples, the content of the pore-forming material was 5 parts by mass when the total of the silicon carbide (SiC) powder and the metallic silicon (Si) powder was 100 parts by mass. Further, in Examples 1 to 9, by controlling the concavo-convex pattern at the tip of the honeycomb formed body 44 formed by extruding the green body 42 from the forming machine 40, a difference in flow rate was generated in the extrusion direction in the honeycomb formed body 44 extruded from the molding machine 40. Specifically, referring to FIG. 5, the flow rate and volume of the green body 42 in the partition wall portion of the honeycomb formed body 44 extruded from the die 41 were made lower than those in the outer peripheral wall portion, and a concave formed pattern was formed at the tip of the honeycomb formed body 44 extruded from the forming machine 40. The control of the flow rate and volume of the green body 42 in the partition wall portions was controlled by the hole diameter and the pitch between the holes in the back plate 43 provided on the upstream side of the die 41 in the path of the green body 42 in the forming machine 40. If the hole diameter of a large number of holes provided in the back plate 43 through which the green body 42 forming the partition wall portion passes is reduced, or the pitch between the holes is increased, the flow rate and volume of the green body 42 forming the partition wall portion can be reduced.

The silicon carbide powder had an average particle size of 20 μm, and the metallic silicon powder had an average particle size of 6 μm. Also, the average particle size of the pore-forming material was 20 μm. The average particle size of the silicon carbide powder, metallic silicon powder and pore-forming material refers to the volume-based arithmetic mean size when the frequency distribution of particle sizes was measured by a laser diffraction method.

### 2. Preparation of Honeycomb Dried Body

The obtained cylindrical green body was formed using an extruder having a pre-determined die structure to obtain a cylindrical honeycomb formed body in which each cell had a hexagonal shape in a cross-section perpendicular to the direction in which the cells extend. This honeycomb formed body was dried by high-frequency dielectric heating, then dried at 120° C. for 2 hours using a hot air dryer, and both end surfaces were cut by a predetermined amount to prepare a honeycomb dried body.

### 3. Preparation of Electrode Layer Forming Paste

Metallic silicon (Si) powder, silicon carbide (SiC) powder, pore-forming material (water-absorbing resin), methyl cellulose, glycerin, and water were mixed with a r planetary centrifugal mixer to prepare an electrode layer forming paste. The Si powder and the SiC powder were blended in a volume ratio of Si powder:SiC powder=40:60. In all the Examples and Comparative Examples, the content of methyl cellulose was 0.5 parts by mass when the total of Si powder and SiC powder was 100 parts by mass. In all the Examples and Comparative Examples, the content of glycerin was 10 parts by mass when the total of Si powder and SiC powder was 100 parts by mass. In all the Examples and Comparative Examples, water was 38 parts by mass when the total of Si powder and SiC powder was 100 parts by mass. In Comparative Example 1, Examples 1 to 4, and 7 to 9, the content of the pore-forming material was 3 parts by mass when the total of Si powder and SiC powder was 100 parts by mass. In Examples 5 and 6, the content of the pore-forming material was smaller than in Comparative Example 1.

The average particle size of the metallic silicon powder was 6 μm. The average particle size of the silicon carbide powder was 35 μm. Further, the average particle size of the pore-forming material was 20 μm. These average particle sizes refer to volume-based arithmetic mean size when the frequency distribution of particle sizes was measured by a laser diffraction method.

### 4. Application of Electrode Layer Forming Paste

The above-mentioned electrode layer forming paste was applied by a curved surface printer on the outer surface of the outer peripheral wall of the above-mentioned honeycomb dried body at two locations so as to face each other and sandwich the central axis. Each application portion was formed in a strip shape on the entire length between both end surfaces of the honeycomb dried body (angle θ=180°, central angle α=90°).

### 5. Firing

After drying the honeycomb structure with the electrode layer forming paste at 120° C., it was degreased at 550° C. for 3 hours in the air atmosphere. Next, the degreased honeycomb structure with the electrode layer forming paste was fired and then oxidization treatment was carried out to obtain a cylindrical honeycomb structure. The firing was performed in an argon atmosphere at 1450° C. for 2 hours. The subsequent oxidation treatment was performed at a temperature of 1050° C. for 6 hours in the air atmosphere. The honeycomb structure had a cylindrical outer shape with a height of 60 mm and a diameter of 103 mm, not including the electrode layers. The partition wall thickness was 0.2 mm (design value), and the cell density was 100 cells/cm².

### II. Characteristic Evaluation

The honeycomb structures obtained under the above manufacturing conditions were evaluated for the following characteristics. In addition, a necessary number of honeycomb structures were prepared for the characteristic evaluation.

### 1. Measurement of Porosity

For the honeycomb structures obtained under the above manufacturing conditions, the porosity P_{W} of the partition walls, the porosity P_{O} of the outer peripheral wall, and the porosity Pe of the electrode layers were determined by the method described above. The results are shown in Table 1.

### 2. Measurement of Outer Wall Thickness

For the honeycomb structures obtained under the above manufacturing conditions, the thickness (T_{O}) of the outer peripheral wall was determined by the method described above. The results are shown in Table 1.

### 3. Electrode Layer Thickness Measurement

For the honeycomb structures obtained under the above manufacturing conditions, the thickness (Te) of the electrode layers was determined by the method described above. The results are shown in Table 1.

### 4. P_{W}/P_{O} and (P_{O}/T_{O})/(Pe/Te))

Based on the above measurement results, P_{W}/P_{O} and (P_{O}/T_{O})/(Pe/Te) were calculated. Table 1 shows the results.

### 5. Thermal Shock Resistance Evaluation

Using a propane gas burner tester equipped with a metal case accommodating the honeycomb structure (sample) obtained under the above manufacturing conditions and a propane gas burner capable of supplying heating gas into the metal case, a sample heating and cooling test was performed. The heating gas was combustion gas generated by burning propane gas with the gas burner (propane gas burner). Then, thermal shock resistance was evaluated by visually confirming whether or not cracks were generated in the sample due to the above heating and cooling test.

Specifically, first, the obtained sample was housed (canned) in the metal case of the propane gas burner tester. At this time, a cushioning material made of ceramics (alumina fiber, mullite fiber, and the like) was interposed between the metal case and the sample. Then, the gas (combustion gas) heated by the propane gas burner was supplied into the metal case and passed through the sample. The temperature condition of the gas flowing into the metal case (inlet gas temperature condition) was set as follows. First, the temperature was raised to a designated temperature in 5 minutes by flowing combustion gas, held at the designated temperature for 10 minutes, then cooled to 100° C. in 5 minutes by flowing air, and held at 100° C. for 10 minutes. The series of operations of such heating, cooling, and holding are referred to as “heating and cooling operations”. After that, the presence or absence of cracks in the sample was visually confirmed. Then, while increasing the designated temperature from 825° C. by 25° C. each time, the above “heating and cooling operations” were repeated. The designated temperature was set in 14 steps starting from 825° C. with each 25° C. step. In other words, the above “heating and cooling operations” were performed until the designated temperature reached 1150° C. As the designated temperature increased, the temperature rise steepness increased, and tensile stress was generated at the boundary between the electrode layers and the outer peripheral wall where the electrode layers were not formed. The results are shown in Table 1. In Table 1, the column of “Thermal shock resistance” indicates the designated temperature when cracks occurred in the honeycomb structure in the heating and cooling test.

TABLE 1

| | | | | | | | | Thermal shock |
|---|---|---|---|---|---|---|---|---|
| | Partition wall | Outer peripheral wall | | Electrode layer | | Partition wall/ | | resistance |
| | Porosity | Porosity | Tickness | Porosity | Tickness | outer peripheral wall | (P_{O}/T_{O})/ | Crack occurrence |
| | (P_{w}) | (P_{O}) | (T_{O}) | (Pₑ) | (Tₑ) | porosity ratio P_{W}//Pₒ | (Pₑ/Tₑ) | temperature |
| Test No. | % | % | mm | % | mm | — | — | ° C. |
| Comparative | 43 | 43 | 0.3 | 40 | 0.23 | 1.00 | 0.82 | 825 |
| Example 1 | | | | | | | | |
| Example 1 | 43 | 40 | 0.3 | 40 | 0.23 | 1.08 | 0.77 | 900 |
| Example 2 | 43 | 38 | 0.3 | 40 | 0.23 | 1.13 | 0.73 | 925 |
| Example 3 | 43 | 35 | 0.3 | 40 | 0.23 | 1.23 | 0.67 | 950 |
| Example 4 | 50 | 35 | 0.3 | 40 | 0.23 | 1.43 | 0.67 | 975 |
| Example 5 | 43 | 40 | 0.3 | 37 | 0.23 | 1.08 | 0.83 | 850 |
| Example 6 | 43 | 40 | 0.3 | 35 | 0.23 | 1.08 | 0.88 | 875 |
| Example 7 | 43 | 40 | 0.3 | 40 | 0.20 | 1.08 | 0.67 | 950 |
| Example 8 | 43 | 40 | 0.3 | 40 | 0.15 | 1.08 | 0.50 | 975 |
| Example 9 | 43 | 40 | 0.3 | 40 | 0.10 | 1.08 | 0.33 | 1000 |

### 6. Discussion

From Table 1, it can be seen that, in Examples 1 to 9 in which the ratio of the porosity P_{W} of the partition walls to the porosity P_{O} of the outer peripheral wall (P_{W}/P_{O}) satisfied 1<P_{W}/P_{O}≤1.8, the crack occurrence temperature was higher than that of Comparative Example 1 which did not satisfy this relationship, and the thermal shock resistance was improved. Furthermore, it can be seen that the larger the P_{W}/P_{O} was, the higher the crack occurrence temperature was. Also, from the comparison of Examples 1, 5, 6, 7, 8 and 9, it can be seen that the crack occurrence temperature tends to rise as (P_{O}/T_{O})/(Pe/Te) decreases.

### DESCRIPTION OF REFERENCE NUMERALS

100: Electrically heated carrier
110: Honeycomb structure
112a: Electrode layer
112b: Electrode layer
113: Partition wall
114: Outer peripheral wall
114i: Inner peripheral surface of outer peripheral wall
115: Cell
116: End surface
118: End surface
120: Underlying layer
130: Metal terminal
142: Partition wall sample
144: Outer peripheral wall sample
146: Electrode layer sample
200: Exhaust gas purification device
220: Metal pipe
240: Electric wire
260: Cushion material

1. A honeycomb structure, comprising:
a honeycomb structure portion, comprising an outer peripheral wall, and partition walls disposed inside the outer peripheral wall and partitioning a plurality of cells forming flow paths from one end surface to the other end surface; and
a pair of electrode layers provided on an outer surface of the outer peripheral wall so as to extend in a strip shape along a direction in which the cells extend and sandwich a central axis of the honeycomb structure portion;
wherein a porosity P_{W} of the partition walls is 30% to 55%, and
a ratio of the porosity P_{W} of the partition walls to a porosity P_{O} of the outer peripheral wall (P_{W}/P_{O}) satisfies 1<P_{W}/P_{O}≤1.8.

2. The honeycomb structure according to claim 1, wherein a thickness Te (unit: mm) of the electrode layers, a porosity Pe (unit: %) of the electrode layers, a thickness T_{O} (unit: mm) of the outer peripheral wall, and the porosity P_{O} (unit: %) of the outer peripheral wall satisfies a relationship 0.25≤(P_{O}/T_{O})/(Pe/Te)≤1.0.

3. The honeycomb structure according to claim 1, wherein the porosity Pe of the electrode layers is 30% to 55%.

4. The honeycomb structure according to claim 1, wherein a material constituting the outer peripheral wall and the electrode layers comprises a silicon carbide-silicon composite material as a main component.

5. The honeycomb structure according to claim 1, wherein the honeycomb structure portion is an integrally formed product.

6. An electrically heated carrier, comprising:
the honeycomb structure according to claim 1; and
metal terminals bonded to an outer surface of each of the pair of electrode layers;

7. An exhaust gas purification device, comprising:
the electrically heated carrier according to claim 6; and
a tubular metal pipe accommodating the electrically heated carrier.
